(19) United States
(12) Patent Application Publication
(10) Pub. No.: US 2008/0025377 A1
(43) Pub. Date: Jan. 31, 2008

(54) METHOD AND DEVICE FOR FREQUENCY DOMAIN COMPENSATION FOR CHANNEL ESTIMATION AT AN OVER SAMPLING RATE IN A TDS_OFDM RECEIVER

(75) Inventors: QIN LIU, Fremont, CA (US); Dinesh Venkatachalam, Fremont, CA (US)

Correspondence Address: FRANKLIN (LIN) YANG, 91 CANTERBURY GATE, LYNBROOK, NY, 11563, US

(73) Assignee: LEGEND SILICON, Fremont, CA (US)

(21) Appl. No.: 11/550,316

(22) Filed: Oct. 17, 2006

Related U.S. Application Data
(60) Provisional application No. 60/820,319, filed on Jul. 25, 2006.

(51) Int. Cl. H04B 1/00

(52) U.S. Cl. 375/150

(57) ABSTRACT

In a TDS-OFDM receiver a device for frequency-domain compensation for channel estimation at an over-sampling rate is provided. The device includes a correlater for correlating a first signal and a second signal; a transformer for transforming the correlated signals into a frequency domain; and an interpolater and truncater block for interpolating and truncating the transformed signal to have the interpolated and truncated, transformed signal as a reference for future use.

### REFERENCE TO RELATED APPLICATIONS

This application claims an invention which was disclosed in Provisional Application No. 60/820,319, filed Jul. 25, 2006 entitled “Receiver For An LDPC based TDS-OFDM Communication System”. The benefit under 35 USC §119(e) of the U.S. provisional application is hereby claimed, and the aforementioned application is hereby incorporated herein by reference.

### FIELD OF THE INVENTION

The present invention relates generally to communication devices. More specifically, the present invention relates to a method and device for frequency-domain compensation for channel estimation at an over-sampling rate in a TDS-OFDM receiver.

### BACKGROUND

OFDM (Orthogonal frequency-division multiplexing) is known. U.S. Pat. No. 3,488,445 to Chang describes an apparatus and method for frequency multiplexing of a plurality of data signals simultaneously on a plurality of mutually orthogonal carrier waves such that overlapping, but band-limited, frequency spectra are produced without casing interchannel and intersymbol interference. Amplitude and phase characteristics of narrow-band filters are specified for each channel in terms of their symmetries alone. The same signal protection against channel noise is provided as though the signals in each channel were transmitted through an independent medium and intersymbol interference were eliminated by reducing the data rate. As the number of channels is increased, the overall data rate approaches the theoretical maximum.

OFDM transreceivers are known. U.S. Pat. No. 5,282,222 to Fattouche et al describes a method for allowing a number of wireless transceivers to exchange information (data, voice or video) with each other. A first frame of information is multiplexed over a number of wideband frequency bands at a first transceiver, and the information transmitted to a second transceiver. The information is received and processed at the second transceiver. The information is differentially encoded using phase shift keying. In addition, after a pre-selected time interval, the first transceiver may transmit again. During the pre-selected time interval, the second transceiver may exchange information with another transceiver in a time duplex fashion. The processing of the signal at the second transceiver may include estimating the phase differential of the transmitted signal and pre-distorting the transmitted signal. A transceiver includes an encoder for encoding information, a wideband frequency division multiplexer for multiplexing the information onto wideband frequency voice channels, and a local oscillator for upconverting the multiplexed information. The apparatus may include a processor for applying a Fourier transform to the multiplexed information to bring the information into the time domain for transmission.

Using PN (pseudo-noise) as the guard interval in an OFDM is known. U.S. Pat. No. 7,072,289 to Yang et al describes a method of estimating timing of at least one of the beginning and the end of a transmitted signal segment in the presence of time delay in a signal transmission channel. Each of a sequence of signal frames is provided with a pseudo-noise (PN) m-sequences, where the PN sequence satisfy selected orthogonality and closures relations. A convolution signal is formed between a received signal and the sequence of PN segments and is subtracted from the received signal to identify the beginning and/or end of a PN segment within the received signal. PN sequences are used for timing recovery, for carrier frequency recovery, for estimation of transmission channel characteristics, for synchronization of received signal frames, and as a replacement for guard intervals in an OFDM context.

As can be seen, although PN possess some desirable qualities, its associated value may fluctuate. This is especially true upon receiving same after transmission. Therefore, it is desirous to provide a correcting factor compensating the fluctuations or inaccuracies.

### SUMMARY OF THE INVENTION

In a TDS-OFDM communications system, a correcting or compensating means is provided for restoring a received PN sequence due to multiple delays. The PN (pseudo-noise) sequence is provided as guard intervals.

In a TDS-OFDM communications system, a correcting or compensating means is provided for restoring a received PN sequence due to attenuations. The PN (pseudo-noise) sequence is provided as guard intervals.

In a TDS-OFDM communications system, a correcting or compensating factor is provided for restoring a received PN sequence. The PN (pseudo-noise) sequence is provided as guard intervals.

In a TDS-OFDM receiver, a correcting or compensating means is provided for restoring a received PN sequence due to multiple delays. The PN (pseudo-noise) sequence is provided as guard intervals.

In a TDS-OFDM receiver, a correcting or compensating means is provided for restoring a received PN sequence due to attenuations. The PN (pseudo-noise) sequence is provided as guard intervals.

In a TDS-OFDM receiver, a correcting or compensating factor is provided for restoring a received PN sequence. The PN (pseudo-noise) sequence is provided as guard intervals.

In a TDS-OFDM receiver, a method and apparatus for frequency-domain compensation for channel estimation at an over-sampling rate are provided. The method and apparatus include a correlater for correlating a first signal and a second signal; a transformer for transforming the correlated signals into a frequency domain; and an interpolater and truncator block for interpolating and truncating the transformed signal to have the interpolated and truncated, transformed signal as a reference for future use.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention

FIG. 1 is an example of a receiver in accordance with some embodiments of the invention.

FIG. 2 is an example of a block diagram of the present invention.

FIG. 2A is an example of a set of graphs corresponding to the block diagram of FIG. 2.

FIG. 3 is an example of a flowchart of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to provide a compensating factor in the frequency domain for compensating the inaccuracies of a received and correlated PN sequence. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of providing a compensating factor in the frequency domain for compensating the inaccuracies of a received and correlated PN sequence described herein. The non-processor circuits may include, but are not limited to, a radio receiver, a radio transmitter, signal drivers, clock circuits, power source circuits, and user input devices. As such, these functions may be interpreted as steps of a method to perform the provision of a compensating factor in the frequency domain for compensating the inaccuracies of a received and correlated PN sequence. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

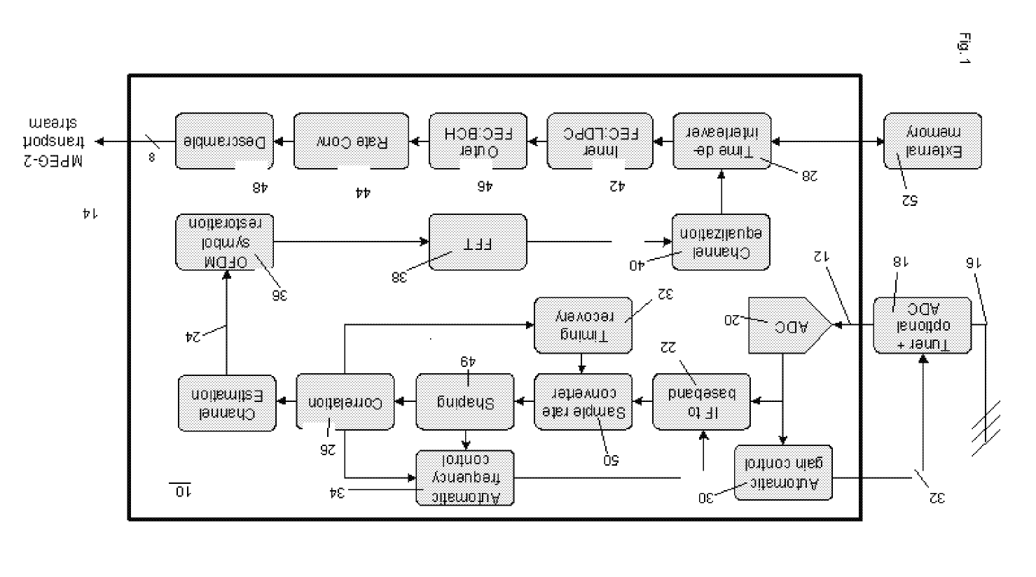

Referring to FIG. 1, a receiver 10 for implementing a LDPC based TDS-OFDM communication system is shown. In other words, FIG. 1 is a block diagram illustrating the functional blocks of an LDPC based TDS-OFDM receiver 10. Demodulation herein follows the principles of TDS-OFDM modulation scheme. Error correction mechanism is based on LDPC. The primary objectives of the receiver 10 is to determine from a noise-perturbed system, which of the finite set of waveforms have been sent by a transmitter and using an assortment of signal processing techniques reproduce the finite set of discrete messages sent by the transmitter.

The block diagram of FIG. 1 illustrates the signals and key processing steps of the receiver 10. It is assumed the input signal 12 to the receiver 10 is a down-converted digital signal. The output signal 14 of receiver 10 is a MPEG-2 transport stream. More specifically, the RF (radio frequency) input signals 16 are received by an RF tuner 18 where the RF input signals are converted to low-IF ( ) or zero-IF signals 12. The low-IF or zero-IF signals 12 are provided to the receiver 10 as analog signals or as digital signals (through an optional analog-to-digital converter 20).

In the receiver 10, the IF signals are converted to base-band signals 22. TDS-OFDM (Time domain synchronous-Orthogonal frequency-division multiplexing) demodulation is then performed according to the parameters of the LDPC (low-density parity-check) based TDS-OFDM modulation scheme. The output of the channel estimation 24 and correlation block 26 is sent to a time de-interleaver 28 and then to the forward error correction block. The output signal 14 of the receiver 10 is a parallel or serial MPEG-2 transport stream including valid data synchronization and clock signals. The configuration parameters of the receiver 10 can be detected or automatically programmed, or manually set. The main configurable parameters for the receiver 10 include: (1) Sub carrier modulation type: QPSK, 16QAM, 64QAM; (2) FEC rate: 0.4, 0.6 and 0.8; (3) Guard interval: 420 or 945 symbols; (4) Time de-interleaver mode: 0, 240 or 720 symbols; (5) Control frames detection; and (6) Channel bandwidth: 6, 7, or 8 MHz.

The functional blocks of the receiver 10 are described as follows.

Automatic gain control (AGC) block 30 compares the input digitized signal strength with a reference. The difference is filtered and the filter value 32 is used to control the gain of the amplifier 18. The analog signal provided by the tuner 12 is sampled by an ADC 20. The resulting signal is centered at a lower IF. For example, sampling a 36 MHz IF signal at 30.4 MHz results in the signal centered at 5.6 MHz. The IF to Baseband block 22 converts the lower IF signal to a complex signal in the baseband. The ADC 20 uses a fixed sampling rate. Conversion from this fixed sampling rate to the OFDM sample rate is achieved using the interpolator in block 22. The timing recovery block 32 computes the timing error and filters the error to drive a Numerically Controlled Oscillator (not shown) that controls the sample timing correction applied in the interpolator of the sample rate converter.

There can be frequency offsets in the input signal 12. The automatic frequency control block 34 calculates the offsets and adjusts the IF to baseband reference IF frequency. To improve capture range and tracking performance, frequency control is done in two stages: coarse and fine. Since the transmitted signal is square root raised cosine filtered, the received signal will be applied with the same function. It is known that signals in a TDS-OFDM system include a PN sequence preceding the IDFT symbol. By correlating the locally generated PN with the incoming signal, it is easy to find the correlation peak (so the frame start can be determined) and other synchronization information such as frequency offset and timing error. Channel time domain response is based on the signal correlation previously obtained. Frequency response is taking the FFT of the time domain response.

In TDS-OFDM, a PN sequence replaces the traditional cyclic prefix. It is thus necessary to remove the PN sequence and restore the channel spreaded OFDM symbol. Block 36 reconstructs the conventional OFDM symbol that can be one-tap equalized. The FFT block 38 performs a 3780 point FFT. Channel equalization 40 is carried out to the FFT 38 transformed data based on the frequency response of the channel. De-rotated data and the channel state information are sent to FEC for further processing.

In the TDS-OFDM receiver 10, the time-deinterleaver 28 is used to increase the resilience to spurious noise. The time-deinterleaver 28 is a convolutional de-interleaver which needs a memory with size B*(B-1)*M/2, where B is the number of the branch, and M is the depth. For the TDS-OFDM receiver 10 of the present embodiment, there are two modes of time-deinterleavering. For mode 1, B=52, M=240, and for mode 2, B=52, M=720.

The LDPC decoder 42 is a soft-decision iterative decoder for decoding, for example, a Quasi-Cyclic Low Density Parity Check (QC-LDPC) code provided by a transmitter (not shown). The LDPC decoder 42 is configured to decode at 3 different rates (i.e. rate 0.4, rate 0.6 and rate 0.8) of QC_LDPC codes by sharing the same piece of hardware. The iteration process is either stopped when it reaches the specified maximum iteration number (full iteration), or when the detected error is free during error detecting and correcting process (partial iteration).

The TDS-OFDM modulation/demodulation system is a multi-rate system based on multiple modulation schemes (QPSK, 16QAM, 64QAM), and multiple coding rates (0.4, 0.6, and 0.8), where QPSK stands for Quad Phase Shift Keying and QAM stands for Quadrature Amplitude Modulation. The output of BCH decoder is bit by bit. According to different modulation scheme and coding rates, the rate conversion block combines the bit output of BCH decoder to bytes, and adjusts the speed of byte output clock to make the receiver 10's MPEG packets outputs evenly distributed during the whole demodulation/decoding process.

The BCH decoder 46 is designed to decode BCH (762, 752) code, which is the shortened binary BCH code of BCH (1023, 1013). The generator polynomial is x̂10+x̂3+1.

Since the data in the transmitter has been randomized using a pseudo-random (PN) sequence before BCH encoder (not shown), the error corrected data by the LDPC/BCH decoder 46 must be de-randomized. The PN sequence is generated by the polynomial 1+x¹⁴+x¹⁵, with initial condition of 100101010000000. The de-scrambler/de-randomizer 48 will be reset to the initial condition for every signal frame. Otherwise, de-scrambler/de-randomizer 48 will be free running until reset again. The least significant 8-bit will be XORed with the input byte stream.

The data flow through the various blocks of the modulator is as follows. The received RF information 16 is processed by a digital terrestrial tuner 18 which picks the frequency bandwidth of choice to be demodulated and then downconverts the signal 16 to a baseband or low-intermediate frequency. This downconverted information 12 is then converted to the Digital domain through an analog-to-digital data converter 20.

The baseband signal after processing by a sample rate converter 50 is converted to symbols. The PN information found in the guard interval is extracted and correlated with a local PN generator to find the time domain impulse response. The FFT of the time domain impulse response gives the estimated channel response. The correlation 26 is also used for the timing recovery 32 and the frequency estimation and correction of the received signal. The OFDM symbol information in the received data is extracted and passed through a 3780 FFT 38 to obtain the symbol information back in the frequency domain. Using the estimated channel estimation previously obtained, the OFDM symbol is equalized and passed to the FEC decoder.

At the FEC decoder, the time-deinterleaver block 28 performs a deconvolution of the transmitted symbol sequence and passes the 3780 blocks to the inner LDPC decoder 42. The LDPC decoder 42 and BCH decoders 46 which run in a serial manner take in exactly 3780 symbols, remove the 36 TPS symbols and process the remaining 3744 symbols and recover the transmitted transport stream information. The rate conversion 44 adjusts the output data rate and the de-randomizer 48 reconstructs the transmitted stream information. An external memory 52 coupled to the receiver 10 provides memory thereto on a predetermined or as needed basis.

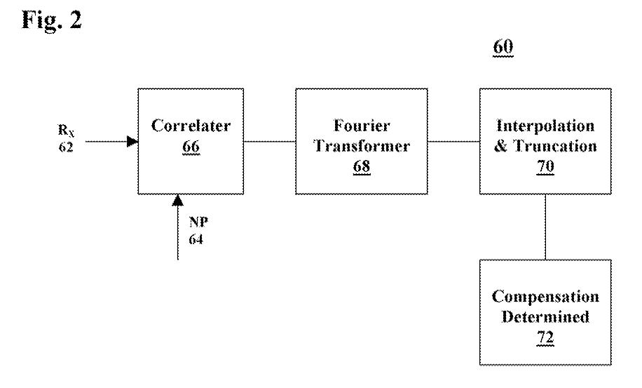

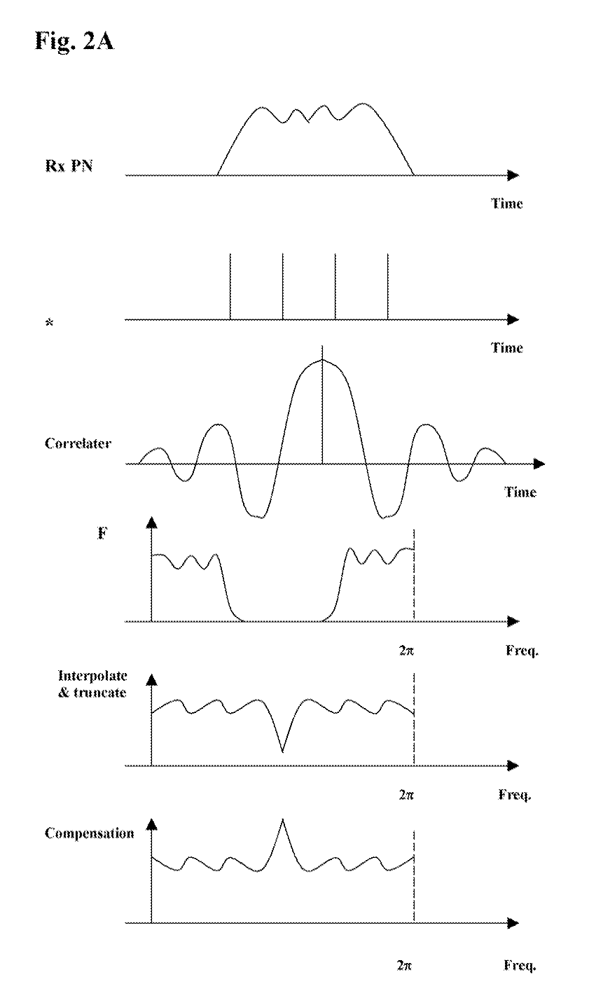

The correlation block 26 and Fourier transform block 38 can be combined to improve the channel estimation 24 all of which is shown in FIGS. 2-2A. Referring to FIGS. 2-2A, an improved correlation means 60 is provided. Initially, a received PN signal 62 including its concomitant multiple delays attenuations based on channel profile as well as interferences is provided together with a native PN 64, with PN 62 being the received over sampled data. Both the received PN signal 62 and native PN 64 are subjected to correlation by correlater 64 in the time domain (as graphically shown in FIG. 2A). The resultant correlation is than transformed into a frequency domain using a Fourier transformer 68. The Fourier transform is typically a digital transform such as a FFT (Fast Fourier Transform). Due to sampling rate conversion, the transformed, correlated signal needs to be interpolated and truncated by block 70 in order to obtain symbol channel response is required for equalization.

As can be seen, the interpolated and truncated graph in the frequency domain reflect the inaccuracies of the restored PN sequence note the steep drop 71 in FIG. 2A. Based upon this, a correction factor for the correlated PN sequence can be provided accordingly. See the last graph of FIG. 2A, note the peak 73 for correcting the highest frequency edges.

In TDS-OFDM communications system, time-domain PN sequences are inserted as guard intervals between consecutive payloads, which may be IDFT blocks. When the time-domain PN sequences are received, the PN sequence is the summation of multiple delays and attenuations based on the channel profile as well as the interferences associated therewith. Therefore, it is desirous to correlate the received signal with a native or the local generated PN (e.g. PN255 for GI420, PN511 for GI945) in an over-sampling rate gives the over-sampled channel response. The correlated information is then transformed into the frequency domain using such transformers as FFT 68. However, frequency equalization requires symbol channel response. This is achieved by interpolating the over sampled channel frequency response, e.g. by linear interpolation.

It is find that even without multipath, this interpolated channel gives limited performance at the highest frequency edges. Therefore, the present invention contemplates a compensation to combat this drawback.

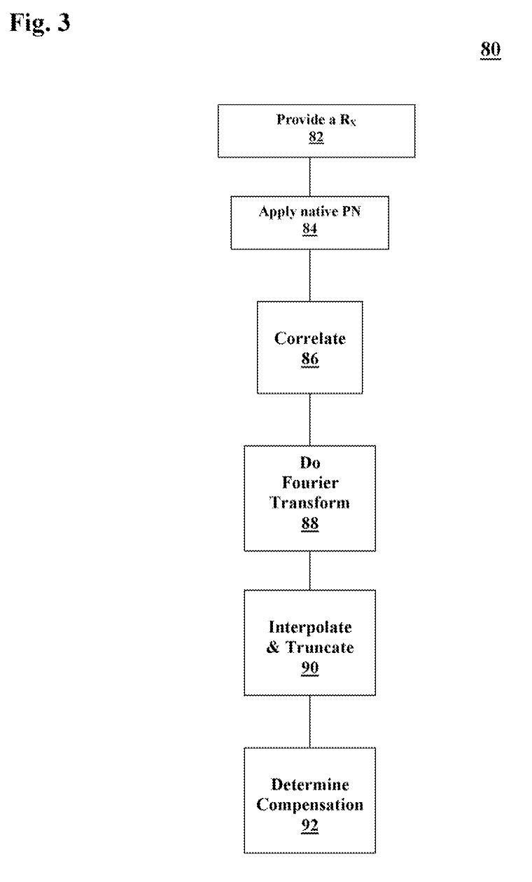

Referring to FIG. 3, a flowchart 80 depicting an example of the present invention is shown. A received signal Rₓ is provided for subsequent correlation (Step 82). A native PN (psuedo-noise) is provided for subsequent correlation with Rₓ (Step 84). A correlater is provided for the correlating the PN with the received signal (Step 86). The correlated result is then subjected to a Fourier Transform into a frequency domain (Step 88). The Fourier transform is typically a digital transform such as a FFT (Fast Fourier Transform). The transformed results are than interpolated and truncated to reflect limited performance at the highest frequency edges of the transformed result (Step 90). A compensation for the highest frequency edges is determined and used as a correction for future usage (Step 92).

It is noted that the present invention contemplates using the PN sequence disclosed in U.S. Pat. No. 7,072,289 to Yang et al which is hereby incorporated herein by reference.

In a TDS-OFDM receiver, a method and apparatus for frequency-domain compensation for channel estimation at an over-sampling rate are provided. The method and apparatus include a correlater for correlating a first signal and a second signal; a transformer for transforming the correlated signals into a frequency domain; and an interpolater and truncater block for interpolating and truncating the transformed signal to have the interpolated and truncated, transformed signal as a reference for future use.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. In a TDS-OFDM receiver a device for frequency-domain compensation for channel estimation at an over-sampling rate, the device comprising:
a correlater for correlating a first signal and a second signal;
a transformer for transforming the correlated signals into a frequency domain; and
an interpolater and truncater block for interpolating and truncating the transformed signal to have the interpolated and truncated, transformed signal as a reference for future use.

2. The device of claim 1 further comprising a compensating block using a reverse of the reference as a compensating factor.

3. The device of claim 1, wherein the first signal comprises a received PN sequence having inaccuracies contained therein.

4. The device of claim 1, wherein the second signal comprises a native PN sequence native to a receiver.

5. The device of claim 1, wherein PN sequences are used as guard intervals between transmitted payloads.

6. In a TDS-OFDM receiver a method for frequency-domain compensation for channel estimation at an over-sampling rate, the method comprising the steps of:
correlating a first signal and a second signal;
transforming the correlated signals into a frequency domain; and
interpolating and truncating the transformed signal to have the interpolated and truncated, transformed signal as a reference for future use.

7. The method of claim 6 further comprising using a reverse of the reference as a compensating factor.

8. The method of claim 6, wherein the first signal comprises a received PN sequence having inaccuracies contained therein.

9. The method of claim 6, wherein the second signal comprises a native PN sequence native to a receiver.

10. The method of claim 6, wherein PN sequences are used as guard intervals between transmitted payloads.
